(19) United States
(12) Patent Application Publication
(10) Pub. No.: US 2013/0182300 A1
(43) Pub. Date: Jul. 18, 2013

(54) SECURITY ELEMENT WITH ACHROMATIC FEATURES

(71) Applicants: Matthias Müller, Bechtsrieth (AT); Stephan Trassl, Saxen (AT); Bart De Gooijer, RC S-Hertogenbosch (NL); Klaus Schmidegg, Linz (AT); Sander De Bruin, Dm Elst (NL)

(72) Inventors: Matthias Müller, Bechtsrieth (AT); Stephan Trassl, Saxen (AT); Bart De Gooijer, RC S-Hertogenbosch (NL); Klaus Schmidegg, Linz (AT); Sander De Bruin, Dm Elst (NL)

(21) Appl. No.: 13/824,607

(22) PCT Filed: Oct. 5, 2011
(86) PCT No.: PCT/EP2011/004955

§ 371 Date: Mar. 18, 2013

(30) Foreign Application Priority Data
Oct. 13, 2010 (EP) 10013580.5

(51) Int. Cl. G03H 1/00

(52) U.S. Cl. CPC G03H 1/0011
USPC 359/2; 427/355; 156/219

(57) ABSTRACT

The invention relates to an achromatic security element for value documents, such as banknotes, cards, ID documents and the like comprising a thermoplastic or a radiation-curable polymer layer, characterised in that the layer is embossed with diffusely reflecting microstructures having sizes in the order of 1-100 μm, a method for producing such security elements, value documents comprising said security elements and a currency system comprising said security elements.

The invention relates to a security element for value documents, cards, banknotes and the like, with an achromatic first level security feature, which is hard to counterfeit.

Holographic security stripes or threads are well known first level security features for banknotes and value documents and provide additional second- and third-level security through an implementation of machine readable and/or forensic elements. Most of these features contain diffractive elements in the form of a surface relief, whose structural elements have sizes in the range of 10-1000 nm, i.e. which are in the range of the wavelength of visible light. The optical effect that is seen by an observer is a rainbow-like color change when the security element is tilted or twisted. Kinematic or flip-flop effects can also be created. More recently, these diffractive features have been combined with non-diffractive or achromatic features, which show a modulation of the reflectivity and/or intensity of the reflected light without splitting it into its spectral components. Special types of such features can mimic a three-dimensional appearance. Feature sizes of such achromatic microstructures are either well below the wavelength of visible light (<100 nm) or well above (>1.5 μm) that. The microstructure can consist of deliberately created irregular, regular or random surface structures.

WO 2008/104277 A discloses a grid image, comprising two or more grid fields which respectively contain a grid pattern that has a plurality of dashed grid lines. At least one of the grid fields is an achromatic grid field having a visual appearance that is dependant on the viewing angle. The grid fields are formed from partial areas that are nested one inside the other. The extension thereof in at least one dimension is below the resolution limit of the naked eye.

DE 10 2007 020 026 A discloses a security paper comprising at least one window covered by a transparent or translucent feature layer with motif zones that are in the form of symbols, patterns or codes. The motif zones comprise achromatic microstructures with angle-dependent transmission and reflection properties giving a different appearance when viewed from opposite sides of the feature layer.

WO 2007/131375 A discloses an element having optically effective surface relief microstructures and a method of making them. The surface relief microstructure has a surface modulation of top regions and bottom regions. In a first lateral direction of the surface area there is in average of at least one transition from a top to a bottom region or vice versa within every 20 μm. In a second lateral direction of the mask which is perpendicular to the first direction there is in average at least one transition from a first to a second zone or vice versa within every 200 μm.

In the microstructure, (i) in the first direction the lateral arrangement of the transitions is non-periodic, and (ii) the top regions substantially lie in the same top relief plateau and the bottom regions substantially lie in the same bottom relief plateau. Through scattering effects, the surface relief microstructures are suitable to display images with a positive-negative image flip, which advantageously have a distinct and saturated color appearance but at the same time do not show any rainbow colors.

WO 2007/027122 discloses a security label comprising a carrier whose back surface is provided with a glue layer for applying the security label to a protected article. The face surface is provided with a visible graphical image embodied thereon. Further the face surface is provided with a profile in the form of a plurality of slots crossing the main image screen structure lines in such a way that a non-homogenous cross-point system is formed, wherein said cross-point system forms an additional latent image displayable on the main image background when an entrance angle is modified or the carrier is observed at a specified oblique angle. The screen relief and/or structure of the main image are provided with geometric distortions, whose value corresponds to the tone scale values of the additional image, and the slot depth is selected in such a way that the violation of the carrier integrity by an attempt of mechanically without authorization separating the security label attached to the protected article surface is taken into account.

EP 0 330 738 A discloses a document which is provided with a macroscopic structure embossed into a substrate. The structure is provided with an optically acting covering and protected beneath a protective cover. The structure consists of several surface portions which are defined by a microscopic relief structure and are different from each other under visual observation as a result of optical diffraction effects. Several of the surface portions measure less than 0.3 mm and can occur individually or in a row in the structure, whereby the distances between the surface portions measure less than 0.3 mm. The document shows a pattern consisting of a mesh of dots and lines to the naked eye. An examiner viewing the document through a magnifying glass will see the dots and the lines dissolve into characters, numbers and other graphic features.

DE 10 2006 03900 A discloses a method for producing documents or labels having security features. The method involves producing single or multi layered raw material by treatment with a suitable laser. The laser parameters are dynamically changed during the production. An engraving of different depth or in different depth is produced by change of the laser parameters during the production of the document or labels and the depth relief is correlated as security characteristic with the mark labeling.

WO 2004/077468 A discloses a safety element having a grid structure. The structure consists of at least a first part provided with a grid constant which is less than a wavelength at which said part is observable and embodied in the form of a relief structure whose relief height is defined in such a way that the zero-order grid image can be observed in a determined spectral range. Said part has a size less than 0.5 mm at least in one direction.

WO 2005/071444 A discloses a grid image consisting of one or several grid fields which respectively contain a grid pattern which influences electromagnetic radiation and which consists of a plurality of dashed grid lines. The dashed grid lines are characterized by the following parameters: orientation, curvature, distance and profile. A grid field of said grid image, which can be recognized separately with the naked eye, contains a grid pattern which influences electromagnetic radiation and which is provided with dashed grid lines for which at least one of the parameters (orientation, curvature, distance and profile) can vary over the surface of the grid field.

WO 2006/133863 A discloses a security document with a transparent security element with a structural layer arranged in a window or in a transparent section of the security document. A first section of the structural layer comprises an asymmetrical diffractive relief structure and the first section has an unexpectedly different optical effect when the security document is viewed from the front and from the back.

WO 01/70516 discloses a die stamp for coins and medals, comprising a hardened surface in which a motif is produced, which motif is constructed solely of a more or less compact series of indentations Each indentation has substantially the same diameter, lying between 0.1 and 0.3 μm, and each indentation being of substantially the same depth.

The disclosed method for manufacturing a die for coins or medals starts from a hardened metallic surface and produces in said surface at least part of a motif by making indentations by laser technology.

WO 03/022597 discloses an object of value made from a sheet-like piece of metallic material. The sheet-like piece is provided with an image which is applied to it with the help of a die, on at least one side.

The information on the die can be obtained with the aid of a laser technique by forming pits therein. The image is formed by a series of elevations comprising essentially the same diameter and height.

WO 2005/077674 discloses a coin or token provided with a relief consisting of ribs and an image. The relief structure, essentially consisting of triangular ribs, is provided with part of said image on one side of the rib and a series of said sides of a series of said ribs forms said image. The parts of the image are formed by making regions with reflective characteristics on the side of the ribs, which differ from the other regions of said side. The regions with different reflective properties comprise a raised surface that extends essentially parallel to the remaining surface of said side.

WO 2009/126030 discloses an authentication feature and a method for producing the authentication feature. A blank is placed between two die halves, having a complementary relief structure. The relief structure is compressed on said blank without the addition of material. The blank comprises a material having a reflective surface. The relief structure comprises grooves and ridges respectively. Impressing is effected in such a manner that each of said ridges or grooves is provided with elevations and depressions within the plane of said ridges and grooves, said elevations and depressions forming an image by reflection.

It is an object of the invention to provide an achromatic embossed security element for value documents, such as banknotes and the like, which is easy to detect, but difficult to counterfeit and does not comprise diffractive elements.

A further object of the invention is to provide a method for making such security elements.

A further object is a currency system comprising coins and banknotes, in which the structures on security element in a banknote resemble structures of the coins.

According to one aspect of the invention there is provided an achromatic security element for value documents, such as banknotes, cards, ID documents and the like comprising a thermoplastic or a radiation-curable polymer layer, characterized in that the layer is embossed with diffusely reflecting microstructures having sizes in the order of 1-100 μm.

According to another aspect of the invention there is provided a method for making the security elements according to the invention, comprising at least the steps of
providing a carrier substrate
coating said carrier substrate with a thermoplastic or a UV-curable polymer coating
embossing said coating with diffusely reflecting microstructures having sizes in the order of 1-100 μm.

The inventive achromatic security element is based on structures that are used also in making dies for minting.

The microstructures are created by laser engraving of a master plate and have sizes, i.e. lateral dimensions and engraving depths, in the order of 1-100 μm, thus well beyond the wavelength of visible light in the non-diffractive regime.

The master plate is usually provided as a metal or polymer plate with a specularly reflecting surface, thus with a low surface roughness. Materials that can be used for master fabrication are for example nickel, steel, brass or polymers such as PMMA, PC, PS or the like. If a laser of sufficient power strikes the master plate surface, the electromagnetic radiation interacts with the master plate material and a part of the master plate at the location of beam impact is removed or altered either thermally (evaporation/melting) or non-thermally (ablation). Due to the removal of material from the surface or the local modification of the surface, the reflection properties are changed at the location of laser impact and show a diffusely reflecting, matte surface finish. Preferably, the surface modification is done non-thermally by ablation.

The lateral and vertical dimensions of the microstructures are ultimately determined by the spot size, type and power of the laser used. While engraving depths for coins can be as high as several 100 μm, an embossed security film usually has an overall thickness below 40 μm including carrier film and all functional layers. The vertical dimensions (perpendicular to the film surface) of laser engraved master structures are thus restricted by the thickness of the embossing layer and lie typically below 10 μm, preferably below 5 μm and more preferably below 2 μm. The lateral resolution of laser engraved structures lies typically below 100 μm, preferably below 50 μm.

The matte appearance of the modified surface areas can be a consequence of the micro-roughness that appears at the base layer of each individual engraved dot or line due to the ablation or melting of material at that point. However, also the mere existence of a recessed dot or line on an otherwise flat surface creates diffuse reflection effects at the edges of the dot or line. In practice, a mixture of both effects will be seen by an observer.

The structures can be combined to form pixelized, photo-realistic raster images, which create half-tone or newspaper-like images from a graphic arrangement of specularly and diffusely reflecting pixels (dots) of uniform or varying sizes. Those images are usually characterized by a rather two-dimensional appearance. Depending on the background illumination and the viewing angle, the optical appearance can either show bright engraved areas on a dark, specular background or matte engraved areas on a bright specular background. Usually, both effects can be seen upon tilting of the security element.

In another embodiment, the structures can resemble embossings that are typically found on coins which suggest great depth and whose brightness changes or inverts upon tilting or twisting.

The engraved structures can also be produced in a way to resemble typical engraved structures on Intaglio printing plates, which are used practically on all known banknotes in circulation. Further the engraved structures can also be produced in a way to resemble a watermark in the paper of a banknote. The ordinary user can thus match the embossed security feature on the thread or stripe to a printed security feature or a watermark on the banknote. The advantage for the end user is that all three essential components for producing a banknote (security feature, paper, print) contain the same image with similar appearance and thus help to efficiently validate the banknote.

Appropriate methods for creating the master plate are disclosed for example in WO 01/70516, WO 03/022597, WO 2005/077674, WO 2009/126030 cited above, whose content is included by reference herein.

The master is then used to create an embossing tool (shim) for replicating above microstructures into either a thermoplastic or a UV-curable polymer coating on a carrier film. The shim manufacturing consists typically of several steps of electroforming and step-and-repeat recombination and yields finally a cylindrical embossing tool to be used in roll-to-roll processes.

However, it is also possible to engrave the above structures directly into a cylindrical tool using an appropriate laser machining setup with sufficient power to manipulate the cylinder surface in the same way as described above for the master plate.

Other types of embossing tools used in alternative feature production routes, such as flat embossing plates (for sheet processing) or segmented embossing cylinders, can be produced in analogous manner.

The polymer layer to be embossed can be provided on a carrier substrate. Suitable carrier substrates are for example carrier films, preferably flexible polymer films consisting of PI, PP, MOPP, PE, PPS, PEEK, PEK, PEI, PSU,

PAEK, LCP, PEN, PBT, PET, PA, PC, COC, POM, ABS, PVC, PTFE, ETFE (ethylentetrafluorethylen), PFA (tetrafluoroethylene-perfluoropropylvinylether-fluorocopolymer), MFA (tetrafluoro-methylene-perfluoorpropylvinylether-fluorcopolymer), PTFE (polytetra-fluoroethylene), PVF (polyvinylfluoride), PVDF (polyvinylidenfluorid), and EFEP (ethylen-tetrafluorethylen-hexafluoropropylene-fluorterpolymer).

These carder films usually have a thickness of 5-700 μm, preferably 5-200 μm, most preferably 5-50 μm.

Furthermore metal films, such as Al—, Cu—, Sn—, Ni—, Fe— or steel, having a thickness of 5-200 μm, preferably 10-80 μm, most preferably 20-50 μm are suitable carrier substrates.

Additionally paper substrates such as cellulose-free or cellulose-containing paper, thermosensitive paper or laminates e.g. with polymer films are suitable carrier substrates. These substrates can have a weight of 20-500 g/m², preferably 40-200 g/m².

The carrier substrate is then provided with a thermoplastic or radiation-curable, preferably UV-curable, embossing lacquer.

The radiation-curable embossing lacquer can for example consist of a radiation-curable lacquer system based on a polyester-, an epoxy- or polyurethane-system comprising one or more different photo initiators commonly known. These photo initiators can initiate curing of the embossing lacquer system in different extent at different wavelengths. For example a first photo initiator can be activated by radiation with a wavelength from 200 to 400 nm, while a second photo initiator can be activated by radiation with a wavelength from 370 to 600 nm. Preferably there is sufficient distance between the two activation wavelengths, so that the excitation of the second photo initiator is not too strong, while the first photo initiator becomes activated. The range, in which the second photo initiator is activated, should be in the transmission wavelength range of the carrier substrate used, if curing is done through the carrier substrate.

For the main curing step electron beam radiation can be used. In this case, no photoinitiator is used, but the crosslinking process in the embossing lacquer is triggered by the electron beam.

Further a water-based varnish can be used as radiation curable embossing lacquer. Preferred are lacquer systems on polyester basis.

The thickness of the embossing lacquer is usually between 5-50 μm, preferably 2-10 μm, most preferably 2-5 μm.

Casting of the surface structure is done for example at elevated temperature by means of pressing the embossing tool into the radiation-curable embossing lacquer, which is pre-cured by activation of the first photo initiator up to the gel state.

If a water-dilutable radiation-curable embossing lacquer is used it may be necessary to introduce a drying step before embossing, for example by IR radiators or thermal convection drying, to remove the water from the embossing lacquer film.

The carrier substrate is brought into contact with the embossing tool which is preferably mounted on a temperature-controlled clamping cylinder. Embossing of the surface structure is preferably made only when the coated carrier substrate is in contact with the embossing tool.

A precise control of the process parameters, like pressure and in particular temperature is necessary to avoid a too rapid or too slow change of the properties of the embossing lacquer.

At the same time as the embossing takes place, final curing of the embossing lacquer and subsequent full curing is effected.

Further the embossing lacquer can consist of a thermoplastic lacquer. The thermoplastic lacquer can be based on MMA or ethyl cellulose or a cycloolefinic polymer which can contain modifiers influencing the thermoplastic or stabilizing properties.

Depending on the basic polymer additives influencing the glass transition temperature, the temperature range in which the lacquer is in a thermoplastic state or the curing properties can be modified.

A lacquer based on MMA preferably comprises nitrocellulose as additive to raise the glass transition temperature.

A lacquer based on cyclo-olefinic polymers preferably comprises polyethylene wax.

A lacquer based on ethyl cellulose preferably comprises commercially available crosslinkers.

The concentration of the basic polymer in the lacquer depends on the kind of the basic polymer, the desired properties and the modifier(s) and is usually between 4 and 50 wt %.

The lacquer is dried but is still in thermoplastic state when it is embossed with the diffusely reflecting microstructures by a conventional hot embossing process, preferably at controlled (elevated) temperature and/or pressure. After embossing the lacquer layer can be cured by radiation or by enhancing temperature, or by imprinting with a crosslinking layer.

The embossed polymer coating is usually transparent, but can be colored by soluble or pigmented colorants to modify the optical appearance of the security element. The thickness of the embossed polymer coating is usually below 10 μm, preferably below 5 μm.

The embossed polymer coating is then metallized to enhance the reflectivity of the surface relief and to maximize the contrast between specularly and diffusely reflecting parts of the surface relief. The metallized layer can be deposited by known PVD- and CVD-processes, preferably in a roll-to-roll vacuum web coating process using thermal evaporation, electron beam evaporation or sputtering. The usage of printing inks containing metal flake pigments can also create a similar optical appearance as by using vacuum-coated layers.

Metallic layers are preferably formed by Al, Sn, Cu, Zn, Pt, Au, Ag, Cr, Ti, Mo, Fe, Pt, Pd or alloys such as Cu—Al, Cu—Sn, Cu—Zn, Iron-alloys, steel, stainless steel or the like.

The metal layer(s) can be applied to the entire surface of the security element or applied only to selected parts of the security element. Such partial metallization layers are either produced by metal deposition and subsequent etching or by using a demetallization process as described for example in WO-A 99/13195.

Those partial metal layers can also be produced in form of a raster or a line grid, where the raster dots can be opaque or semitransparent. Preferably, the grid represents a half-tone image.

A partial metal layer can be applied in register to the embossing to combine a security feature visible in reflective light (embossing+metal) and feature visible in transmitted light (partial metal layer) in the same place on the security element.

The optical appearance of the security element resembles greatly the appearance of a brightly polished metal coin. By an appropriate choice of the metallic coating, the appearance can be matched to the material used in minting (silver, copper, brass, nickel, etc.), either by using the same alloy or an alloy with similar optical properties.

In a further embodiment the metallic coating can be replaced by a colored metal compound coating, which yields bright reflective colors, whose hue can be tuned over a wide range.

The colored metallic layer can consist of a metal compound layer having a defined thickness and defined optical parameters (spectral absorption, refractive index, transparency) and of at least one at least partially reflecting layer.

Metal compounds include transparent or semi transparent materials, having defined or selective absorption properties and preferably having a refraction index >1.6. Preferably oxides, sulfides or fluorides of metals or semiconductors are used.

Examples of suitable metal compounds are oxides of Ti, Zn, Cu, Zr, Al, Cr, Mg, Hf, Si, Y oder Ta, complex oxides such as indium-tin-oxide (ITO), antimony-tin-Oxide (ATO), fluorine-tin-oxide (FTO), Zn-chromate or ZnS, BaF₂, MgF₂, CaF₂.

The at least partially reflecting layer consists of a metal layer made from Al, Sn, Cu, Zn, Pt, Au, Ag, Cr, Ti, Mo, Fe, Pt, Pd or alloys such as Cu—Al, Cu—Sn, Cu—Zn, Iron-alloys, steel, stainless steel or the like.

The layers are preferably applied using a commonly known PVD or CVD-processes.

When the colored metal layer is viewed from the side of the metal compound layer, light first passes the metal compound layer, is then reflected by the at least partially reflecting layer and then again passes the metal compound layer. The visual appearance is determined by the defined spectral absorption and interference in the metal compound layer in combination with the spectral reflection properties of the at least partially reflection layer.

Therefore the visual appearance is determined by the following parameters:
optical properties of the metal compound layer
thickness of the metal compound layer
spectral reflection properties of the at least partially reflecting layer

The optical properties of the metal compound layer depend on the material, which defines the refractive index and the absorption properties of the layer.

For example a TiOₓ layer has a refractive index of about 2.2, a CuOₓ layer has a refractive index of 2.0 and MgF₂ of 1.38. Absorption is an intrinsic property of the material and usually characteristic, i.e. the absorption in a defined wavelength range is higher than in other wavelength ranges, for example if the absorption edge is in the range of the visible light or if the absorption coefficient increases with increasing wavelength. The absorption coefficient may be influenced by stoichiometry, for example in case of oxides by controlling the oxygen partial pressure during the deposition process. If Ti is deposited in vacuum without oxygen an opaque layer is formed at a thickness of about 30-50 nm, if oxygen is added during the deposition process the layer becomes more and more transparent, until a stoichiometric oxide compound (TiO₂) is formed, which shows negligible absorption at the same layer thickness.

A semitransparent layer of a metal compound layer, whose optical thickness (product of refraction index and geometric thickness n·d) is in the range of the wavelength of the incident light (50-2000 nm) produces interference effects caused by partial reflection at its upper and lower interfaces to neighboring layers with different refractive indices. This results in a wavelength selective amplification or attenuation of the incident light which manifests as a color effect, which changes according to the thickness of the layer. Therefore a defined material, such as TiOₓ or CuOₓ with constant stoichiometry will show a different color depending only on the geometric thickness of the layer.

For example a CuOₓ layer having a thickness of 80 nm attenuates the green and blue spectral components and enhances the yellow component of incident white light, whereas a 160 nm CuOₓ layer of same stoichiometry attenuates the red and blue component and enhances the green component of incident white light.

Further the color of the colored metal layer can be influenced by the at least partially reflecting layer. For example an aluminum layer shows continuous reflection over the whole visible spectral range, while copper appears reddish, i.e. the red component of light is reflected stronger than the blue component. A man skilled in the art will easily find out how other metal layers affect the appearance of the respective colored metal layer.

According to yet another embodiment the inventive security feature can contain two or more at least partially overlapping or spaced apart metallic layers to yield bi- or multimetallic reflection layers. Preferably the different metals have different visual appearance or color and combinations of metals, metal alloys, metal compounds and colored metal layers can produce visually attractive optical effects. Similar bi-metallic effects are well known from coins, which show a silverish appearance on an outer ring of the coin and a brass-like appearance in the center part of the coin.

The thickness of the metallic layer(s) is usually in the range of 1-100 nm, preferably in the range of 10-50 nm. The choice of thickness depends on the material and the desired optical properties.

According to another embodiment of the invention the inventive feature can be combined with further security elements such as security prints having fluorescent, phosphorescent, thermochromic, optically variable, magnetic or electrically conductive properties.

The optical properties of such a layer are defined by pigments, for example by luminescence pigments, which fluoresce or phosphoresce in the visible, the UV or IR spectral range, effect pigments, like liquid crystals, iridescent, brasses and/or multilayer color shifting pigments, as well as thermochromic pigments. These pigments can be used alone or in various combinations.

Magnetic properties of the layer are provided by paramagnetic, diamagnetic or ferromagnetic pigments. Preferably magnetic vamishes or lacquers containing Fe-oxides, Fe, Ni, Co and their alloys, Ba— or Co-ferrites, magnetically hard or soft Fe— or steel compounds are used in aqueous or solvent borne dispersions.

Electrically conductive properties of such a layer are provided by lacquers or varnishes comprising electrically conductive pigments such as graphite, carbon black or electrically conductive organic or inorganic polymers, metal pigments (Cu, Al, Ag, Au, Fe, Cr, and the like), metal alloys such as Cu/Zn, Cu/AI or the like or amorphous or crystalline ceramic pigments such as ITO and the like. Further doped or non-doped semiconductors such as Si, Ge or ionic conductors, such as amorphous or crystalline metal oxides or metal sulfides may be comprised in the electrically conductive layer.

Further the security element can comprise diffractive elements, such as holograms, diffractive grids, surface reliefs and the like which may be produced according to EP 1 310 381.

The security element can further be coated on one or both sides with a protective lacquer, which can be pigmented or non-pigmented. Such coatings are well known in the art and serve to enhance physical or chemical resistances of the security element.

Further the security element can be provided on one or both sides with an adhesive layer, for example a cold- or hot sealing or a self adhesive layer, which can be pigmented or non-pigmented.

The security element as describe above may be laminated to a further carrier substrate, which can contain further security elements.

The security element can be produced in form of stripes, threads or patches and applied onto or at least partially embedded into natural or synthetic paper to produce a substrate for value documents. Furthermore, a usage in plastic cards (credit cards, ID cards, . . . ) or travel documents (passports, visa, . . . ) is also possible.

In a further embodiment the security element can be visible in a recess or an aperture in the substrate from one or both sides.

The security element can be partially embedded in or applied onto the substrate with the help of the adhesive layer, whereby the carrier substrate of the security element can remain on the security element or peeled off when the functional layers are transferred to the paper.

Since identical structures can be used in the minting and banknote manufacturing process, the optical appearance of coins and banknotes can be matched to give the public an identical first-level feature, thus creating a novel currency system.

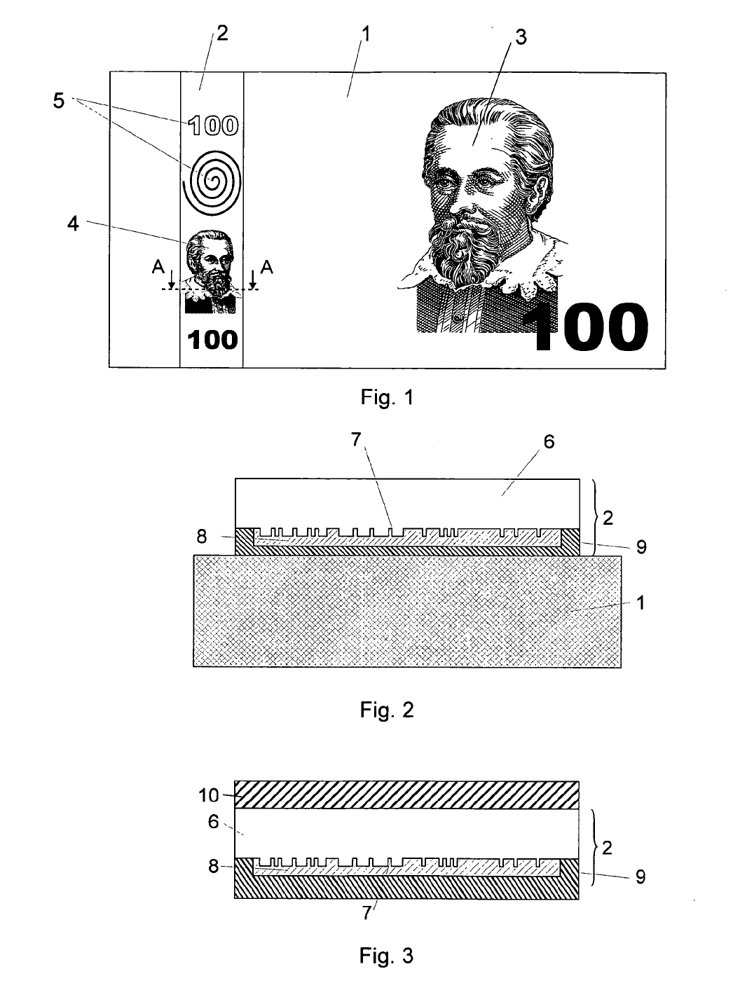

In the following FIGS. 1-5, the reference numerals denote:
1 Value document according to invention
2 Security element applied to the surface of the value document
3 Intaglio print on value document
4 Security feature with achromatic structures
5 Partial metallic layer
6 Transparent embossing lacquer
7 Achromatic surface relief structure
8 Partial metallic layer applied to surface relief structure
9 Adhesive layer
10 Carrier substrate
11 Specularly reflecting of the surface
12 Diffusely reflecting part of the surface
13 Specular reflection
14 Diffuse reflection at laser modified surface
15 Diffuse reflection at step edge

FIG. 1 shows a value document 1 with a security element 2 as claimed by the invention, which is applied to the surface of the value document. The value document contains another security feature in form of an Intaglio print 3, which resembles the security feature 4 of the security element. The security element 2 is further equipped with a partial metallic layer 5 without embossing.

FIG. 2 shows a cross-sectional view of the security document of FIG. 1. The security element 2 is applied to the surface of value document 1 and fixed by an adhesive layer 9. The adhesive layer is typically a heat-seal adhesive which is activated by elevated temperature. The security element consists essentially of three layers: an embossing lacquer 6 with an achromatic surface relief structure, a partial metallic layer 8 applied at least in areas of the surface relief structure and the adhesive layer 9. The viewer observes the security element through the transparent embossing lacquer 6 and sees the reflected light from the metallic layer 8. The film setup shown in FIG. 2 is well suited for use in highly durable value documents, since the metal layer 8 is protected between the embossing lacquer 6 and the adhesive layer 9.

FIG. 3 shows the security element 2 before transfer application to the banknote surface. The layers of the security element 2 are produced on a carrier substrate 10 in successive steps. During the transfer process, the adhesive coated side of the security element is brought into contact with the substrate of the value document. Upon exertion of pressure and/or elevated temperature, the adhesive 9 is activated and fixes the security element 2 to the substrate surface. The carrier substrate 10 can then be removed. Usually, the thickness of security element 2 is much lower than the thickness of the carrier film. A removal of security film 2 from the substrate is thus not possible without destroying it.

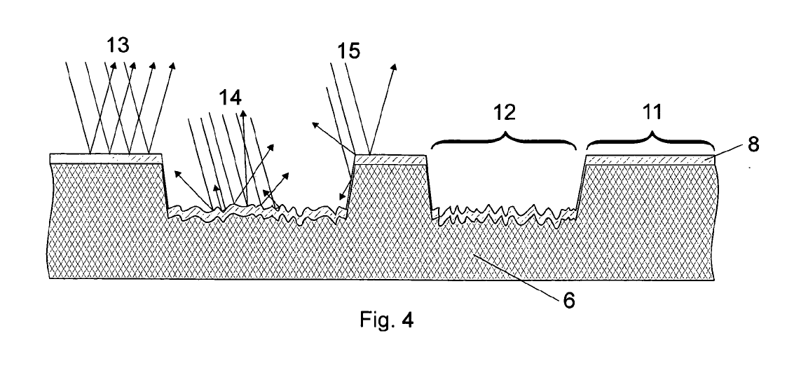

FIG. 4 shows a schematic magnified view of the microstructured surface of the embossing lacquer 6 after deposition of the metallic layer 8. The surface can be divided into specularly reflecting regions 11 with low surface roughness and diffusely reflecting regions 12 with a random surface roughness. On such a surface, three different modes of light reflection can be identified:
A region 13, where incident light is specularly reflected, i.e. the angles of incidence and reflection are identical. This region shows a mirror-like optical appearance.
A region 14, where incident light is diffusely reflected or scattered at random irregularities of the surface. Due to the non-periodicity of the surface topography, no diffractive effects can be seen. The optical appearance of this region is a matte finish.
A region 15, where incident light is scattered at edges of the surface relief. A part of the incident light is reflected from the surface, while other parts are reflected away from an observer. Depending of the viewing angle, reflection from the sidewalls of the embossing can be seen at oblique angles. This may lead to a situation where the reflectance of the security element seems to invert upon tilting.

1. Achromatic security element for value documents, such as banknotes, cards, ID documents and the like comprising a thermoplastic or a radiation-curable polymer layer, characterized in that the layer is embossed with diffusely reflecting microstructures having sizes in the order of 1-100 μm.

2. Achromatic security element according to claim 1 characterized in that the thermoplastic or radiation curable layer is provided on a carrier substrate.

3. Achromatic security element according to claim 1, characterized in that the diffusely reflecting microstructures are combined to form photorealistic half-tone images.

4. Achromatic security element according to claim 1, characterized in that the diffusely reflecting microstructures are combined to form an image with three dimensional depth appearance.

5. Achromatic security element according to claim 1, characterized in that the diffusely reflecting microstructures are combined to form an image that resembles a banknote print (Intaglio print) or a watermark.

6. Achromatic security element according to claim 1, characterized in that the diffusely reflecting microstructures form photorealistic half-tone images and/or images with three dimensional depth appearances and/or resemble a banknote print or watermark.

7. Achromatic security element according to claim 1, characterized in that the diffusely reflecting microstructures are fully or partially coated with a metal layer, a metal alloy layer, a metal compound layer. a metal ink or a high refractive index layer.

8. Achromatic security element according to claim 1, characterized in that the diffusely reflecting microstructures are fully or partially coated by a colored metal compound coating.

9. Achromatic security element according to claim 7, characterized in that the diffusely reflecting microstructures are coated by at least two different layers selected from the group consisting of metallic, metallic ink, metallic alloy, metallic compound or high refractive index layers.

10. Achromatic security element according to claim 1, characterized in that the diffusely reflecting microstructures are arranged in a photorealistic half-tone image and that the partial metal layer is also applied as a half-tone image.

11. Achromatic security element according to claim 1 characterized in that the security element further comprises a continuous or partial coating having fluorescent, phosphorescent, thermochromic, optically variable, magnetic and/or electrically conductive properties.

12. Achromatic security element according to claim 1 further comprising a protective layer.

13. Achromatic security element according to claim 1 further comprising an adhesive layer such as a cold or hot sealing layer or a self-adhesive layer.

14. Value document comprising a security element according to claim 1, characterized in that the security element is at least partially embedded into the value document.

15. Value document comprising a security element according to claim 1, characterized in that the security element is applied to the surface of the value document with or without removing the carrier film.

16. Method for making the security elements according to the invention, comprising the steps of
providing a carrier substrate,
coating said carrier substrate with a thermoplastic or a radiation curable polymer coating,
embossing said coating with diffusely reflecting microstructures having sizes in the order of 1-100 μm.

17. Method according to claim 16 further comprising the step of coating the diffusely reflecting microstructures with one or at least two different layers selected from the group consisting of metallic, metallic ink, metallic alloy, metallic compound or high refractive index layers.

18. Method according to claim 16, further comprising the step of applying a continuous or partial coating having fluorescent, phosphorescent, thermochromic, optically variable, magnetic and/or electrically conductive properties.

19. Method according to claim 16 further comprising the steps of applying a protective and/or an adhesive layer.

20. Method according to claim 16 further comprising the step of laminating a second carrier substrate to the first carrier substrate.

21. Currency system comprising banknotes and coins, characterized in that the banknotes and coins comprise diffusely reflecting microstructures having sizes in the order of 1-100 μm which resemble each other.
